(19) United States
(12) Patent Application Publication
(10) Pub. No.: US 2008/0163566 A1
(43) Pub. Date: Jul. 10, 2008

(54) Multi-dimensional paver edging

(76) Inventor: Joe Bella, Plainfield, IL (US)

Correspondence Address: MCHALE & SLAVIN, P.A., 2855 PGA BLVD, PALM BEACH GARDENS, FL, 33410, US

(21) Appl. No.: 11/620,904

(22) Filed: Jan. 8, 2007

(51) Int. Cl. A01G 1/08; E02D 27/00

(52) U.S. Cl. 52/102; 47/33

(57) ABSTRACT

Among the several aspects and features of the present invention may be noted the provision of a paver edging device for use as an interface or boundary of a paved region. In one aspect the edging device includes an elongate strip extending in a longitudinal direction having a flange portion integrally formed to an edge of the elongate strip and extending in a transverse direction outwardly from one side of the strip. The flange is provided with a series of contoured-V cut-out portions having contoured edges. The contoured-V cut-out portions are connected along the rear edge thereof with a plurality of rear rail segments. Bending or contouring of the strip therefore requires removal of a portion of the rear rail segments.

### FIELD OF THE INVENTION

This invention relates generally to landscaping, and more specifically to a paver edging strip formed by the process of injection molding from a suitable plastic material for use as an interface or boundary between a paver bricked area and other types of terrain.

### BACKGROUND OF THE INVENTION

The need for paver edging devices to separate paved areas from different kinds of terrain is well known. There are several basic types of brick edging devices utilized for a similar application, namely edging grassy areas. One type includes a single upright elongate strip with a horizontal flange member or a plurality of discrete individual flap members extending away from the elongate strip to provide support for the strip or an anchoring base for the device. However, edgers known in the prior art provided with these horizontal extending flanges or flaps have been designed so that the flange prevents bending of the strip or the flaps interfere with one another when the strip is bent, thereby limiting the angle to which the edger can be bent. Prior art edgers have also not been produced to accommodate standard size pavers when the strips are bent, but rely on the pavers being cut to provide a snug fit. Furthermore, in prior art edging devices, the horizontal flange or flaps or other means of support for the upright strip is commonly designed to remain uncovered by grass, pavers or other substrate, thus producing a wide border between areas, comprising both the upright strip and the support means.

In general, the edging strips are flat or include an L-shape wherein a vertical wall abuts and supports the edge of paving blocks or other features, and in the case of an L-shape a horizontal footing rests on the ground surface.

For instance, U.S. Pat. No. 5,301,461 to Zwier, discloses a flat landscape edging assembly which includes first and second elongated strips of material having longitudinal top and bottom edges. The flat strips are adapted for end-to-end alignment along longitudinal axes thereof with mutually adjacent ends of each of the strips having an end segment that is laterally offset with respect to a remainder segment by an amount that is equal to or just slightly greater than a thickness dimension of the strips. An anchoring structure is also provided for anchoring the end-to-end connected strips to a ground surface, forming a part of a landscape setting. This type of edging fails to provide the stability of L-shaped edging in either a linear or contoured arrangement. A drawback to this kind of arrangement is that during frost heaving the stake is driven up out of the ground, and since the stake is securely interlocked with the strip, the strip is also dislodged from the ground.

U.S. Pat. No. 6,568,126 to Womack, discloses a T-shaped border edging for securing a pond liner as well as the soil surrounding a decorative pond. A series of tabs enable the edging to flex, each tab having a preformed hole to accept a fastener. Each fastener has a pointed shank, which is driven through the preformed hole of a respective one of the tabs of the flange, through the outer margin of the lining sheet, into the land border of the pond.

Strobel, Jr., U.S. Pat. No. 6,071,038, discloses an elongated L-shaped holding device for holding paving blocks in place. The vertical portion of the device abuts the pavers and the horizontal portion of the device extends away from the pavers. One end of each section includes a tongue for cooperation with a groove in an adjacent section. However, the device is limited to linear sections making the device unsuitable for use around contoured paver layouts and the like.

U.S. Pat. No. 6,085,458 to Gau, discloses an edging member. The edging member includes small generally L-shaped segments pivotally connected together. A generally circular segment may be present to cover the ground below the edging member when the edging member is angularly joined to an adjacent edging member. While this device is particularly suited for contoured layouts, the numerous pivotal connections make linear sections of edging difficult to install.

U.S. Pat. No. 5,640,801 to Rynberk, discloses an assembly of a divider and stakes for use where the height of the flower bed surface is greater than that of the adjoining ground. The divider comprises an extruded length of plastic including an enlarged upper section and a flange formed integrally with the upper section and extending along the length of the upper section and downwardly from the upper section to a bottom edge. A plurality of flaps are formed integrally with the bottom edge and extend laterally outwardly from the bottom edge. At least one slot is formed in each flap, the slots being adapted for receipt of stakes.

Zwier, U.S. Pat. No. 6,379,078, discloses a pavement restraint structure including edging pieces having apertures. Connecting elements have protrusions that are secured in the edging apertures such that adjacent edging pieces have a gap therebetween. Anchoring elements are received by slotted apertures in the edging pieces.

Burnham, U.S. Pat. No. 7,051,477, discloses an edge support for a lawn. The device includes an elongate generally L-shaped support member having a base part fixable to ground beneath the lawn, and an upstanding wall part to retain an edge of the lawn. The base part has elongate apertures to allow grass roots to grow therethrough. The base part may have several zones at which it may be cut or broken to permit bending of the wall part. The edge support is provided with connectors to connect it to further edge supports via flanges on the wall part and the base part.

McIntyre et al., U.S. Pat. No. 6,324,783, discloses a molded plastic landscape edging strip with integrally molded plastic spikes that can be severed on site for use in installation and also serve during storage and handling to stiffen the rear edge of the flexible plastic edging strip. The edging strip has an elongate vertical wall with bottom edge, front and rear faces, a horizontal footing extending rearwardly from the bottom edge with longitudinally spaced apart apertures.

Kurtz et al., U.S. Pat. No. 5,212,917, discloses a brick edging device. The edging device includes an elongate extruded aluminum L-shaped strip having a vertical portion and a flange portion. The flange is provided with a series of V-shaped cut-out portions spaced along the length thereof. The portion of the flange located between the cut-outs form individual flaps, each flap having an aperture extending therethrough to receive a spike.

While these devices are generally suitable for their intended purpose, they include various drawbacks that have not been entirely addressed by the prior art. For example, the construction of the tabs used for securing the edging to the ground surface do not permit 90° bends without overlapping of the tabs. In devices such as that disclosed by Kurtz, where 90° bends are permitted, the edges of the tabs must abut directly together. Abutting the tabs is often difficult due to the sand and other debris associated with landscaping and most particularly with installing pavers. In addition, these devices do not include a rear rail that substantially prevents bending of the edging for improved linear paver layouts. The rear rail further includes thinned sections to allow easy removal of portions of the rear rail for contouring selective sections of the edging strip. In addition, none of the devices include material reducing apertures to save in usage of raw materials during formation of the edging strips.

Thus, what is needed in the art is a paver edging device that includes an integrally formed rear rail for maintaining straight sections of edging when desired. The rear rail should also include thinned sections which allow a user to cut out portions of the rear rail leaving tabs that are configured and spaced to allow for bending of the strip to a variety of angles and can accommodate a paver of a standard size without the need for cutting of the paver to obtain a snug fit. The tabs should be configured to include contoured edges that allow clearance between the edges of the tabs through bends of at least 90° to allow for debris and the like between the tabs without interference. A connector member should be provided which does not detract from the from the appearance of the assembled edging. The edging should be constructed by a process such as injection or extrusion molding to include integrally formed stake apertures and material saving openings. When in place, the device should provide a sharp well-defined boundary between the bordered areas.

### SUMMARY OF THE INVENTION

Among the several aspects and features of the present invention may be noted the provision of a paver edging formed by the process of injection or extrusion molding from a suitable plastic material for use as an interface or boundary between a paver bricked area and other types of terrain.

In one embodiment of the invention a paver edging device includes an elongate strip extending in a longitudinal direction and having first and second opposed sides and opposed edges. A flange member is attached to the elongate strip along a first edge thereof and extends transversely from a first side of the elongate strip. The flange includes a plurality of spaced tab members secured together at a rear edge thereof with a rear rail member. There are a plurality of spaced, contoured-V cut-out portions separating adjacent tabs wherein the apex of the cut-out contoured-V portion is flat and is spaced from the first edge of the elongate strip and the edges of the contoured-V cut-out are contoured. There is an angle of at least 90 degrees between the sides of the contoured-V cut-outs so that the elongate strip can be bent at a position between the flat apex and said first angle to an angle of at least 90 degrees. The contoured edges permit at least 90 degree bends with only the distal ends of the edges contacting and a space between the remainder of the edges to prevent interference from debris and the like. The rear rail is formed to include thin sections which allow a user to remove portions of the rear rail. This construction allows a user to form straight sections of edging as well as contoured sections within the same or different strips of edging. The tabs used to secure the edging to the ground include integrally formed stake apertures and material saving openings. The stake apertures are constructed and arranged to cooperate with multiple types of stakes to provide versatility. Some of the stakes for securing the edging to the ground include ground engaging barbs to prevent heaving and the like. A connector member is provided that can cooperate with adjacent stakes as well as the end stake apertures of adjacently positioned paver edging members to construct extended edgings. In this manner the connector member can be used to connect the flanges of cut or trimmed edging members.

Thus, an objective of the instant invention is to provide a paver edging that includes a flange having a plurality of spaced tab members secured together at a rear edge thereof with a rear rail member.

Another objective of the instant invention is to disclose a paver edging wherein the rear rail includes integrally formed thin sections to permit removal of portions of the rear rail to permit contouring of the edging device where desired.

Yet another objective of the invention is to provide a tab member that includes contoured edges allowing at least 90 degree bends without interference between the edges of the tabs or debris between the tabs.

Still yet another objective of the invention is to provide a connector member for connecting adjacently positioned paver edging members which does not detract from the appearance of the assembled edging.

An even further objective of the invention is to provide a connector member that can be used connect trimmed edging members.

Other objectives and advantages of this invention will become apparent from the following description taken in conjunction with the accompanying drawings wherein are set forth, by way of illustration and example, certain embodiments of this invention. The drawings constitute a part of the specification and include exemplary embodiments of the present invention and illustrate various objectives and features thereof.

### BRIEF DESCRIPTION OF THE FIGURES

FIG. 1 is a front perspective view illustrating a paver edging device with the teachings of the present invention;

FIG. 2 is a partial top elevational view illustrating the contoured-V cut-out of the present invention;

FIG. 3 is a partial perspective view illustrating an inward 90 degree bend accomplished with the teachings of the present invention;

FIG. 4 is a partial perspective view illustrating an outward 90 degree bend accomplished with the teachings of the present invention;

FIG. 5 is a perspective view illustrating various spike members suitable for use with the present invention;

FIG. 6 is a side view illustrating a connection bracket suitable for use with the present invention.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

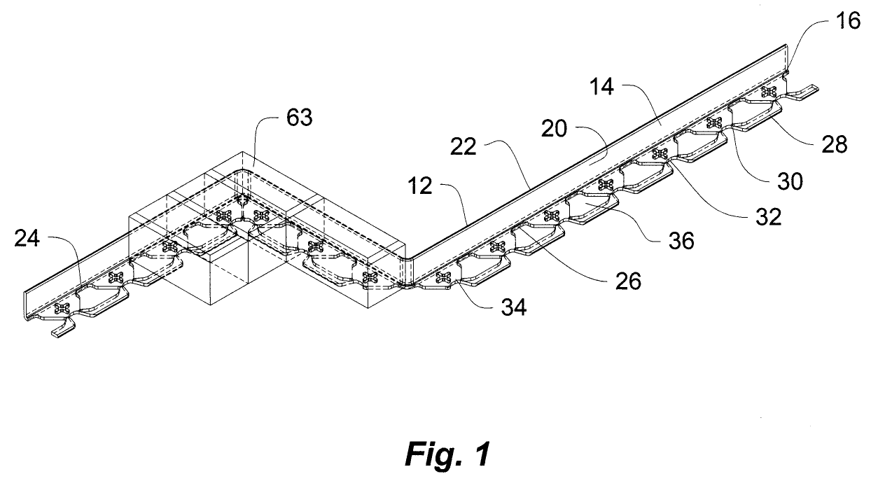

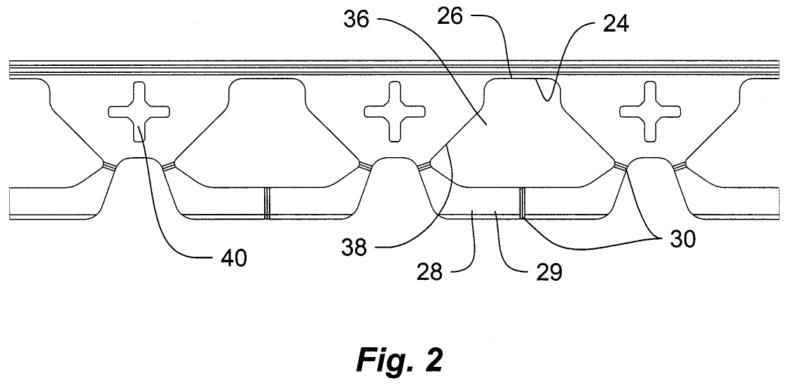

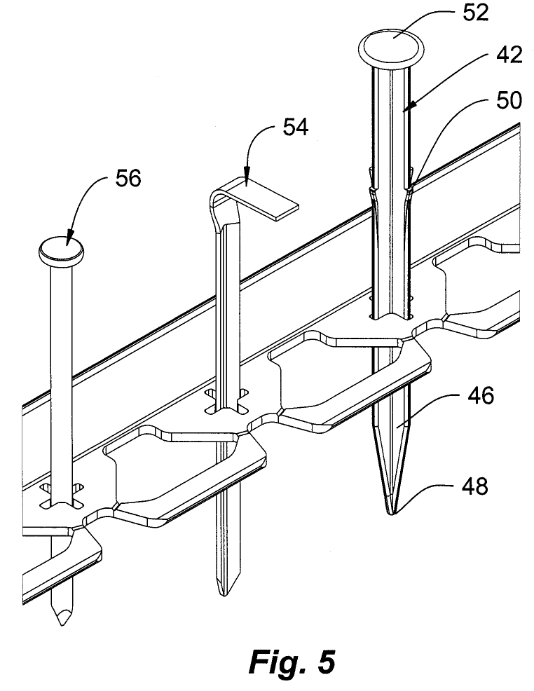

In referring to the drawings, like numerals refer to like parts. A preferred embodiment of a paver edging device 10 embodying the subject invention is shown in FIGS. 1-6 and includes an elongate strip portion 12 having a substantially planar portion 14, a first edge 16, a second opposed edge 18, and wherein planar portion 14 includes opposed sides 20 and 22. In one embodiment the elongate strip portion 12 includes spaced, longitudinal strengthening ribs (not shown) integrally formed therewith and extending along the full length of strip 12 to provide additional strength to the elongate portion. The paver edger 10 is provided with a substantially planar flange member 32 connected to the strip portion 12 along edge 16 thereof. Flange 32 extends transversely with respect to the planar portion 14 and away from side 20. Flange 32 includes a plurality of tab members 34 separated from each other by contoured-V cut-out portions shown generally at 36. An apex 24 of the contoured-V cut-out portions is flat, not pointed, wherein the flat apex portions 24 are substantially parallel with respect to side 20 and spaced about 0.1 inches from side 20 defining a projecting portion 26.

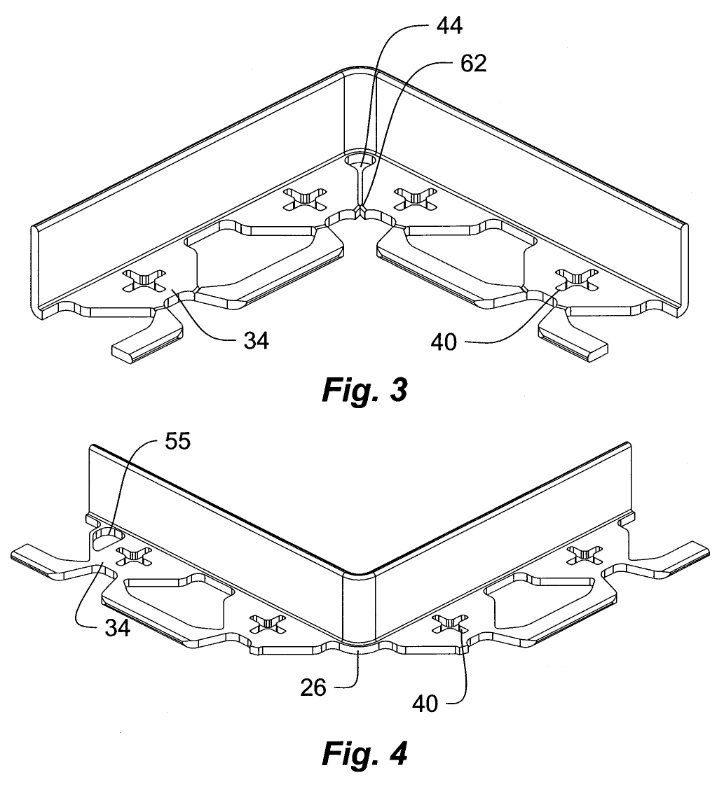

In a most preferred embodiment, the tab members 34 are secured together at a rear edge thereof with a plurality of structural rear rail segments 28. The rear rail segments prevent substantial bending of the elongate strip 12 either inward as shown in FIG. 3 or outwards as shown in FIG. 4 to provide for rigid linear sections of paver layouts. The rear rail segments are provided with thin sections 30 to permit easy cutting and removal of rear rail segments. The thin sections may be formed at predetermined spaced intervals to provide various predetermined bending angles. As shown, one portion 29 of a rear rail segment 28 may be removed to provide a 45 degree bend while the entire rear rail segment may be removed to provide a 90 degree bend. It should also be noted that the thin sections may be spaced at any suitable increment to provide 1°,5°,10° or any other suitable bending angle without departing from the scope of the invention. After removal of the rear rail segments or portions of the rear rail segments the strip 12 may be bent or shaped by bending strip 12, inwardly or outwardly with respect to the tabs 32, at points adjacent to the flat apex portions 24 as illustrated in FIGS. 3 and 4. The presence of projecting portion 26 mitigates against wrinkling, tearing or ripping of the elongate strip 12 when the latter is being bent or shaped. The size of the tab members 34 and spacing between the contoured-V cut-out portions may be chosen to correspond to the width of a known standard size paver.

In one embodiment of the paver edger 10 the contoured edges 38 of the contoured-V cut-outs are spaced to allow an inward bending angle of about 90 degrees when at least one segment of the rear rail is removed. It will be appreciated that in other embodiments the contoured edges 38 of the tabs may be spaced to allow inward bending angles of greater than 90 degrees. It should also be appreciated that the edges of the contoured-V are shaped so that when the elongated strip is bent inwardly a gap 44 (FIG. 3) remains between the edges to prevent interference from dirt and debris, always present during installation of pavers. In a most preferred embodiment the rear rail 28 is trimmed along the thin sections 30 so that the distal tips 62 of the contoured-V contact when bent inward as shown in FIG. 3.

The tabs 34 are each provided with an aperture 40 of a suitable size to receive therein one of a variety of stakes 42, 54 and 56 for various applications and arrangements. In a most preferred embodiment, the stake aperture preferably has a conjugate shape to the shank portion 46 of the stake 42. The stake 42 is provided at one end with a sharpened end 48 adapted to be driven into the ground, at least one integrally formed barb 50 located along the shank 46, and an enlarged head portion 52 at the other end thereof. The conjugate engagement between the stake and the strip inhibits the strip from rotating with respect to the stake and in addition maintains the perpendicular positioning of the elongate strip.

The paver edger 10 is preferably formed from polymeric material, e.g. plastic, through the process of injection molding whereby the elongated rail, contoured-V cut-outs, tabs, rear rail segments and stake apertures are formed integrally to the paver edging. In one embodiment the paver edging 10 may include material saving apertures 55 (FIG. 4) to save raw materials in the formation of the paver edging. Injection molding of the paver edging offers significant strength, stability and versatility advantages over roll forming as utilized in the prior art. Injection molding facilitates forming thicker and/or thinner portions within the same paver edging for areas of high or low stress concentrations such as is required with the elongate strip and tabs. In addition, the formation of thicker and thinner sections facilitate integral formation of the thin sections utilized in the rear rail for easy trimming and removal of desired sections.

Alternatively, the paver edger may be formed through the process of extrusion molding. After extrusion of an L-shaped edger blank, the flange portion 32 of the blank would then be stamped, in one or more operations of a punch press or similar device, to remove the material necessary to form the stake apertures 40, contoured-V cut-outs 36, rear rail portions 29 and material saving apertures 55. The thin sections may be formed by performing a coining type operation.

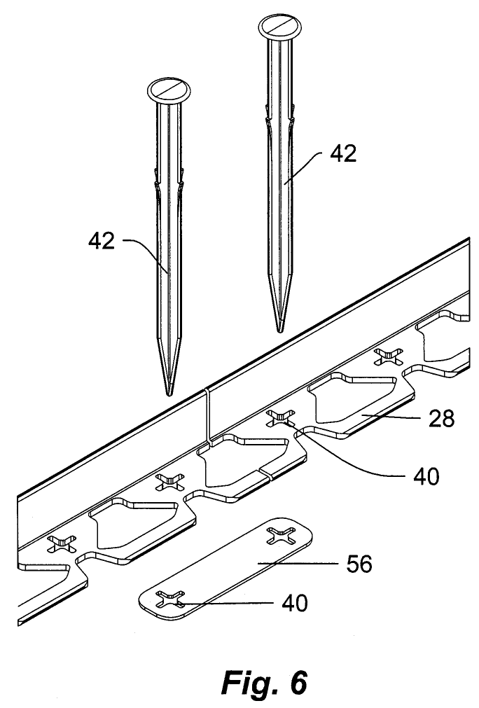

In one embodiment, several individual paver edgers 10 may be collinearly coupled together using connector members 56 such as those shown in FIG. 6. The connector members are generally an elongated strip having stake apertures 40 spaced a suitable distance apart to cooperate with the end stake apertures of adjacent collinearly positioned paver edgers 10. The bracket may be positioned on either the upper or lower side of the flange member but is preferably positioned on the lower side in order to allow the pavers to be placed snug against strip 12. Stakes can be extended through the stake apertures of the edging and the connector members to connect the strips. The construction of the connector member allows the paver edging strips to be cut or shortened without affecting the connectivity of the adjacently positioned edging.

In operation, the rear rail segments 28 are trimmed along the paver edger 10 and then shaped or bent as desired before being secured to the ground at the boundary of a region where pavers are to be placed. To secure the paver edging 10 in place, stakes 42, 54, 56 are driven through apertures 40 into the ground until stake head is flush with the top surface of a tab 32. Pavers 63 and the like may then be laid flush against strip 12 directly on top of the tabs 34, as shown in ghost outline at 63 in FIG. 1.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A paver edging device, comprising:
an elongate strip extending in a longitudinal direction and having first and second opposed sides and opposed edges;
a flange member integrally formed to the elongate strip along a first edge thereof and extending transversely from a first side of the elongate strip, said flange member including a plurality of spaced tab members, said tab members each provided with an aperture for receiving a spike therein, a plurality of spaced, contoured-V cut-out portions separating adjacent tabs, said contoured-V cut-out portions each having an apex and two contoured sides, said contoured sides each having a distal end, wherein said apex of said contoured-V cut-out portion is flat and is spaced from said first edge of said elongate strip, there being an angle of at least 90 degrees between said contoured sides of each said contoured-V cut-out so that said elongate strip can be bent at a position between said flat apex and said first edge to an angle of at least 90 degrees, wherein said contoured sides of said contoured-V cut-out have a contoured shape so that only said distal ends of said contoured sides contact upon said at least 90 degree bend.

2. The paver edging device of claim 1 wherein said tab members are secured together at a rear edge thereof with at least one integrally formed structural rear rail, wherein said at least one rear rail prevents substantial bending of said elongate strip between said tabs, wherein a portion of said rear rail must be removed to bend said elongate strip between said tabs.

3. The paver edging device of claim 2 wherein said rear rail includes thin sections to permit easy cutting and removal of portions thereof.

4. The paver edging device of claim 3 wherein said thin sections are formed at predetermined increments to permit bending said elongate strip to predetermined angles.

5. The paver edging device of claim 4 wherein said thin sections are formed at 10 degree increments.

6. The paver edging device of claim 4 wherein said thin sections are formed at 5 degree increments.

7. The paver edging device of claim 2 wherein said rear rail is formed as a plurality of rear rail segments extending each extending between at least two of said tab members.

8. The paver edging device of claim 7 wherein each of said rear rail segments includes at least one thin section to permit easy cutting and removal of said rear rail segments.

9. The paver edging device of claim 1 including at least one stake suitable to be driven into the ground, said stake including at least one barb integrally formed thereto for engaging a ground surface, said stake being receivable by said stake aperture.

10. The paver edging device of claim 9 wherein said stake aperture has a substantially conjugate shape to a cross sectional shape of said stake.

11. The paver edging device of claim 1 wherein said paver edging device is formed of a suitable polymeric material by the process of injection molding, whereby said elongate strip and said tabs are formed as integral components, wherein said contoured edges and said stake apertures are integrally formed during said injection molding process.

12. The paver edging device of claim 1 wherein said paver edging device is formed of a suitable polymeric material by the process of extrusion, whereby said elongate strip and said tabs are formed as integral components, wherein said contoured edges and said stake apertures are formed during a punch press operation.

13. A paver edging device, comprising:
an elongate strip extending in a longitudinal direction and having first and second opposed sides and opposed edges;
a flange member integrally formed to said elongate strip along a first edge thereof and extending transversely from a first side of the elongate strip, said flange including a plurality of spaced tab members, said tab members each provided with an aperture for receiving a spike therein, a plurality of spaced, contoured-V cut-out portions separating adjacent tabs, said contoured-V cut-out portions including two contoured sides separated by a flat apex, said sides of said contoured-V cut-outs being shaped so that only a distal end of each said side contact each other upon bending of said elongate strip, there being an angle of at least 90 degrees between said sides of said contoured-V cut-outs so that said elongate strip can be bent at a position between said flat apex and said first edge to an angle of at least 90 degrees.

14. The paver edging device of claim 13 wherein said apex of said contoured-V cut-out portion is spaced from the first edge of the elongate strip.

15. The paver edging device of claim 13 wherein said tab members are secured together at a rear edge thereof with a plurality of integrally formed structural rear rail segments, wherein said rear rail segments prevent substantial bending of said elongate strip, wherein a portion of said rear rail must be removed to bend said elongate strip between said tabs.

16. The paver edging device of claim 15 wherein portions of said rear rail are formed thin to permit easy cutting and removal of sections thereof.

17. The paver edging device of claim 13 including a connector member for collinearly connecting two paver edging devices, said connector member including a substantially flat elongate strip having at least two stake apertures extending therethrough, said at least two stake apertures being suitably spaced to align with an end stake aperture of two collinearly positioned paver edging devices, whereby a stake may be extended through said stake apertures of said paver edging device and said connector member for collinear connection of said collinearly positioned paver edging devices.
